(19) United States
(12) Patent Application Publication
(10) Pub. No.: US 2022/0129446 A1
(43) Pub. Date: Apr. 28, 2022

(54) Distributed Ledger Management Method, Distributed Ledger System, And Node

(71) Applicant: Hitachi, Ltd., Tokyo (JP)

(72) Inventor: Nao Nishijima, Tokyo (JP)

(21) Appl. No.: 17/450,927

(22) Filed: Oct. 14, 2021

(30) Foreign Application Priority Data
Oct. 27, 2020 (JP) 2020-179715

(51) Int. Cl. G06F 16/23; G06F 16/27; G06F 21/64; G06F 21/60

(52) U.S. Cl. CPC G06F 16/2379; G06F 21/602; G06F 21/64; G06F 16/27

(57) ABSTRACT

A distributed ledger management method implemented by a predetermined management node configured to perform processing, includes: building a distributed ledger node for endorsement in restoration of a distributed ledger system or addition of a distributed ledger node (304); giving a state database copied from an existing node to the distributed ledger node for endorsement to perform the endorsement (305) and setting the distributed ledger node for endorsement as a broadcast destination of a transaction (306); and monitoring a status of block recalculation that is based on a block at a certain time point and that is performed in a normal distributed ledger node for the restoration or the addition (307, 308) and changing the broadcast destination of the transaction to the normal distributed ledger node (310) when calculation of a latest block is detected (309).

### CROSS-REFERENCE TO RELATED APPLICATIONS

This application claims priority pursuant to Japanese patent application No. 2020-179715, filed on Oct. 27, 2020, the entire disclosure of which is incorporated herein by reference.

### BACKGROUND

### Technical Field

The present disclosure relates to a distributed ledger management method, a distributed ledger system, and a node.

### Related Art

A blockchain is one of elements forming the distributed ledger technology. The blockchain is a succession of blocks each obtained by grouping transactions that are issued by nodes and for which consensus has been formed, every certain period, and is one type of distributed database.

Each of the blocks forming the blockchain described above includes a time stamp and a hash of a previous block (in the succession of the blockchain). Accordingly, it is extremely difficult to retrospectively change a certain one block in the blockchain. In other words, it can be said that the blockchain has high tamper resistance.

Such a block chain is held at multiple locations, that is distributed ledger nodes on a distributed ledger network with the contents thereof being the same. In other words, data held in the block chain is managed in the distributed ledger nodes in a distributed manner. Specifically, there is no situation where data is held and managed in a centralized manner as in a conventional system.

Moreover, applying smart contract to the aforementioned block chain technology enables transactions to be automatically executed and managed as appropriate and enables flexible implementation of various functions. It is also possible to implement endorsement in which validities of results obtained by executing transactions in smart contract are verified.

Note that the smart contract is to be executed on the latest information on processing described in the transaction of the latest block. A state database holds this latest information.

In the endorsement, the correctness of data of the transaction is guaranteed based on the latest information held by the state database described above. Accordingly, when the state database and the block are lost due to a failure or the like, it is necessary to download the block from another organization that is not affected by such a failure or the like, and rebuild the state database.

As a conventional technique for reducing download time of the block described above, there is proposed, for example, a distributed computing system (see Japanese Patent Application Publication No. 2019-20816) that reduces time required for recovery in a distributed computing system.

In this technique, at least one node or a separate calculator in the distributed computing system including multiple nodes present at multiple locations executes processing of (A) determining one or more locations of one or more nodes holding the same one or more data sets as those held by a node being a recovery target among the multiple nodes and (B) determining a restore destination location that is a location of a node to be a restore destination of the same one or more data sets, from the multiple locations based on the determined one or more locations, wherein the recovery target location is the location where there is the restore target node.

When the total size of the block to be downloaded increases, the download time and the time of rebuilding the state database in the subsequent step also increase. Accordingly, a reasonable amount of time is required before start of endorsement of new transactions that are still issued one after another also after the occurrence of the failure or the like described above. In a conventional technique, the entire system is in a shutdown state until the rebuilding of the state database is completed.

Although the aforementioned conventional technique takes reduction of download time into consideration, there is no consideration relating to endorsement. Accordingly, the conventional technique only reduces the download time and there is no proposal of a technique that can reduce time in the aforementioned shutdown state as much as possible.

### SUMMARY

Thus, an object of the present disclosure is to provide a technique that can speed up rebuilding of the state database and reduce downtime of the entire system.

A distributed ledger management method to solve the above objective implemented by a predetermined management node configured to perform processing, comprising: building a distributed ledger node for endorsement in restoration of a distributed ledger system or addition of a distributed ledger node; giving a state database copied from an existing node to the distributed ledger node for endorsement to perform the endorsement and setting the distributed ledger node for endorsement as a broadcast destination of a transaction; and monitoring a status of block recalculation that is based on a block at a certain time point and that is performed in a normal distributed ledger node for the restoration or the addition and changing the broadcast destination of the transaction to the normal distributed ledger node when calculation of a latest block is detected.

A distributed ledger system comprising a predetermined management node, wherein the predetermined management node includes a computation device that is configured to perform processing of: building a distributed ledger node for endorsement in restoration of the distributed ledger system or addition of a distributed ledger node; giving a state database copied from an existing node to the distributed ledger node for endorsement to perform the endorsement and setting the distributed ledger node for endorsement as a broadcast destination of a transaction; and monitoring a status of block recalculation that is based on a block at a certain time point and that is performed in a normal distributed ledger node for the restoration or the addition and changing the broadcast destination of the transaction to the normal distributed ledger node when calculation of a latest block is detected.

Anode comprising a computation device that performs processing of: building a distributed ledger node for endorsement in restoration of a distributed ledger system or addition of a distributed ledger node; giving a state database copied from an existing node to the distributed ledger node for endorsement to perform the endorsement and setting the distributed ledger node for endorsement as a broadcast destination of a transaction; and monitoring a status of block recalculation that is based on a block at a certain time point and that is performed in a normal distributed ledger node for the restoration or the addition and changing the broadcast destination of the transaction to the normal distributed ledger node when calculation of a latest block is detected.

The present disclosure can speed up rebuilding of the state database and reduce downtime of the entire system.

### BRIEF DESCRIPTION OF THE DRAWINGS

FIG. 1 is a diagram illustrating a configuration example of a distributed ledger system in an embodiment.

FIG. 2 is a block diagram illustrating a configuration example of the distributed ledger node in the embodiment.

FIG. 3 is a diagram illustrating a configuration example of a provisional node in the embodiment.

FIG. 4 is a diagram illustrating a configuration example of a dependable node in the embodiment.

FIG. 5 is a diagram illustrating a flowchart example of the dependable node in the embodiment.

### DETAILED DESCRIPTION OF EMBODIMENTS

### <Configuration Example of Distributed Ledger System>

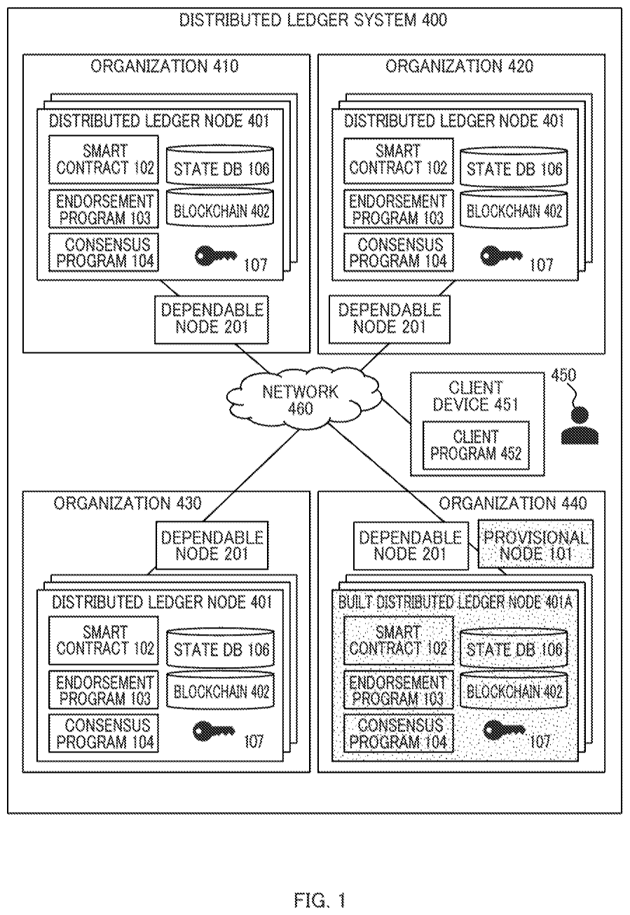

An embodiment of the present disclosure is described below in detail by using drawings. FIG. 1 is a diagram illustrating a configuration example of a distributed ledger system 400 in the embodiment. The distributed ledger system 400 illustrated in FIG. 1 is formed of distributed ledger nodes 401 and dependable nodes 201 in multiple organizations.

In the example of FIG. 1, the distributed ledger system 400 is formed of the distributed ledger nodes 401 and the dependable nodes 201 of four organizations 410, 420, 430, and 440.

Each of the distributed ledger nodes 401 of the organizations includes a smart contract 102, an endorsement program 103, a consensus program 104, a state database 106, a secret key 107, and a blockchain 402.

Meanwhile, the dependable node 201 included in each organization is a management node in the embodiment. Specifically, an entity that executes a distributed ledger management method of the embodiment is the dependable node 201.

The dependable node 201 is communicably coupled to the distributed ledger node 401 of the organization to which the dependable node 201 belongs and to the dependable nodes 201 and the distributed ledger nodes 401 of the other organizations via an appropriate network 460.

Moreover, each of the multiple organizations includes one or multiple distributed ledger nodes 401. The distributed ledger nodes 401 are communicably coupled to one another via the aforementioned network 460.

A client device 451 is also coupled to the network 460. The client device 451 is, for example, a general information processing apparatus such as a PC or a tablet terminal operated by a client 450 whose is a person in charge of a task in a company or the like. The client 450 operates the client device 451 and performs various tasks by using a client program 452.

The aforementioned client device 451 executes the client program 452 on the client device 451 and broadcasts a transaction issued with the execution of the client program 452, to the distributed ledger nodes 401 of the organizations via the network 460.

Meanwhile, the distributed ledger node 401 of each organization executes endorsement processes for the broadcasted transaction by using a function of the endorsement program 103 of the distributed ledger node 401. The series of aforementioned processes such as issuing of a transaction and endorsement relating to the transaction is the same as the series of processes executed in a normal distributed ledger system.

### <Configuration Example of Distributed Ledger Node>

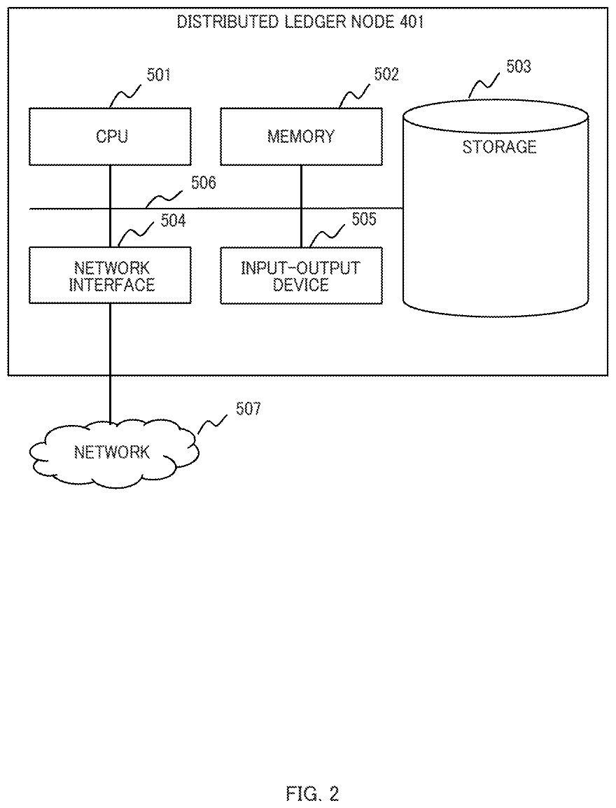

FIG. 2 illustrates a configuration example of the distributed ledger node 401 in the embodiment. The distributed ledger node 401 of the embodiment is implemented by, for example, a server apparatus. However, the mode of the distributed ledger node 401 is not limited to this example and the distributed ledger node 401 may also be implemented by multiple physical servers of any type.

The distributed ledger node 401 illustrated in FIG. 2 is a distributed ledger node that is operating in a sound state without being affected by, for example, a failure or the like, and includes no provisional node 101 built (restored or added) by the dependable node 201. Meanwhile, the distributed ledger node 401A includes the provisional node 101 that is built by the dependable node 201 and performs block recalculation.

The distributed ledger node 401A built as described above is, for example, a node that executes block recalculation processing based on the state database 106 obtained from the distributed ledger node 401 of the other organization. Accordingly, operations of the distributed ledger node 401A in this case correspond to the aforementioned block recalculation processing for restoration (for example, a situation where a failure has occurred in the distributed ledger node 401 of a certain organization and thus the distributed ledger node 401 is to be restored) or addition (for example, a situation where a distributed ledger node of a new organization is to be added to the distributed ledger system 400) in the distributed ledger system 400.

The distributed ledger node 401 (including the concept of the distributed ledger node 401A. The same applies hereinafter) in the embodiment includes a CPU 501, a memory 502, a storage 503, a network interface 504, and an input-output device 505. Moreover, these configurations are coupled to one another via an interface 506 such as an internal bus.

The CPU 501 implements various functions by executing a program recorded in the memory 502.

The memory 502 is a volatile storage device such as a random access memory (RAM) in which the program to be executed by the CPU 501 is recorded and in which various pieces of information are temporarily recorded in execution of the program.

The storage 503 is a non-volatile storage device such as a hard disk drive (HDD) or a solid state drive (SSD) that stores the blockchain 402 and various pieces of data.

The network interface 504 provides an interface for coupling the distributed ledger node 401 to a network.

The input-output device 505 is formed of a keyboard and a mouse that receive input operations made by the user or devices such as a display and a speaker that output processing results of the CPU 501.

### <Configuration Example of Provisional Node>

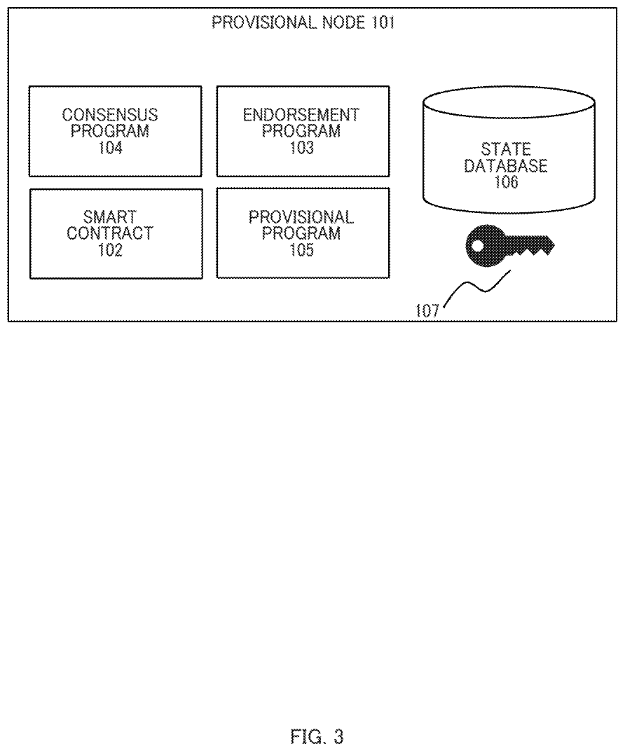

FIG. 3 is a diagram illustrating a configuration example of the provisional node 101 in the embodiment. The provisional node 101 is a node built by (a builder program 204 of) the dependable node 201 that is the management node in the present disclosure.

The provisional node 101 is a distributed ledger node for endorsement and is a node that executes endorsement for the transaction issued by the client device 451, based on the state database. Note that the state database used herein is, for example, a state database obtained and copied from another existing distributed ledger node 401 by the dependable node 201.

Moreover, the provisional node 101 described above is anode that temporarily exists and is built in a form of, for example, virtual PC by using predetermined resources of the dependable node 201 or the distributed ledger system 400. An existing technique can be used as appropriate as a method of building such a virtual PC.

The provisional node 101 of the embodiment includes the smart contract 102, the endorsement program 103, a provisional program 105, the consensus program 104, the state database 106, and the secret key 107.

Among these elements, the smart contract 102 is a program that executes (information processing depending on) a contract of contents agreed on by the organizations and is executed by the endorsement program 103.

The endorsement program 103 executes the smart contract 102 and leaves a trail on the execution result by performing electronic signature with the secret key 107.

The consensus program 104 receives, from the client device 451 of each organization, an execution result of the smart contract 102 to which the signature of the organization is given and checks whether signatures of the organizations as many as required are gathered.

When the result of the aforementioned check is that the signatures as many as required are gathered, the consensus program 104 sends the transaction to the consensus program 104 of the provisional node 101 of each organization and achieves consensus on the order of transaction.

Moreover, the consensus program 104 then receives a transaction issued by any of the nodes in the distributed ledger system 400, stores the received transaction in a block, and distributes the block to the distributed ledger nodes 401 of the respective organizations.

The provisional program 105 receives a transaction from the client device 451 of each organization and executes the endorsement program 103 for the transaction by using data of the state database 106.

Moreover, the provisional program 105 transfers a transaction of obtaining a block from the client device 451 of each organization and a transaction that cannot be processed by using only the state database 106, to the other organizations.

The state database 106 is a database obtained and copied from another existing distributed ledger node 401 and stores latest results of data operations of the transactions included in the blocks. The smart contract 102 executes the processing by using values in the state database 106.

### <Configuration Example of Dependable Node>

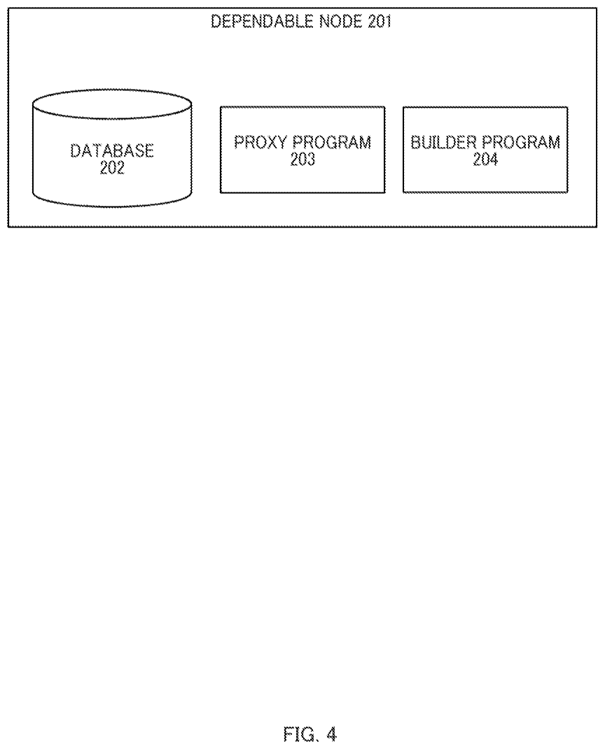

FIG. 4 illustrates a configuration example of a dependable node 201 in the embodiment. The dependable node 201 of the embodiment is the management node in tams of the present disclosure. The dependable node 201 includes, for example, a database 202, a proxy program 203, and a builder program 204.

Among these elements, the database 202 holds information on access points of distributed ledger nodes capable of endorsement. The distributed ledger nodes capable of endorsement include the provisional node 101 in addition to the existing distributed ledger nodes 401 that are not affected by failures or the like and are operating without trouble.

Accordingly, in the database 202, identification information of the distributed ledger nodes capable of endorsement and information on the access points of these distributed ledger nodes are determined. Among these pieces of information, the information on the access points can be assumed to be values such as, for example, IP addresses of corresponding nodes and port numbers of the nodes in a network interface. The port numbers are numbers of ports that receive the transactions.

The proxy program 203 is a program that, in response to reception of a transaction from the client device 451 or the like outside the organization, refers to the database 202 and transfers the received transaction to the node capable of endorsement.

Moreover, the proxy program 203 regularly monitors the distributed ledger nodes 401 and, when detecting a state where any of the distributed ledger nodes 401 is unable to be accessed or perform endorsement, requests the builder program 204 to build a node capable of endorsement, that is the provisional node 101.

After receiving the aforementioned request from the proxy program 203, the builder program 204 builds the provisional node 101 according to a predetermined protocol. Moreover, the builder program 204 writes information on an access point of the built provisional node 101 into the database 202. The information on the access point is a value determined by the builder program 204 in the building of the provisional node 101.

Moreover, the builder program 204 builds the distributed ledger node 401A being the target of restoration or addition and obtains and copies the latest blocks from the distributed ledger node 401 of another organization. As described above, the distributed ledger node 401A built herein is the node that performs recalculation of the blocks.

The dependable node 201 monitors the blocks of the blockchain 402 in the distributed ledger node 401A. Accordingly, when the dependable node 201 detects that all latest blocks are gathered in the blockchain 402 by the aforementioned block recalculation and the state database 106 held by the distributed ledger node 401A is in the latest state, the dependable node 201 changes the access point set for this organization in the database 202 from the access point of the provisional node 101 to the access point of the distributed ledger node 401A.

### <Distributed Ledger Management Method>

Actual procedures of the distributed ledger management method in the embodiment are described below based on the drawings. Various operations corresponding to the distributed ledger management method described below are achieved by, for example, a program read out to a memory or the like and executed by the dependable node 201. This program is formed of codes for performing various operations described below.

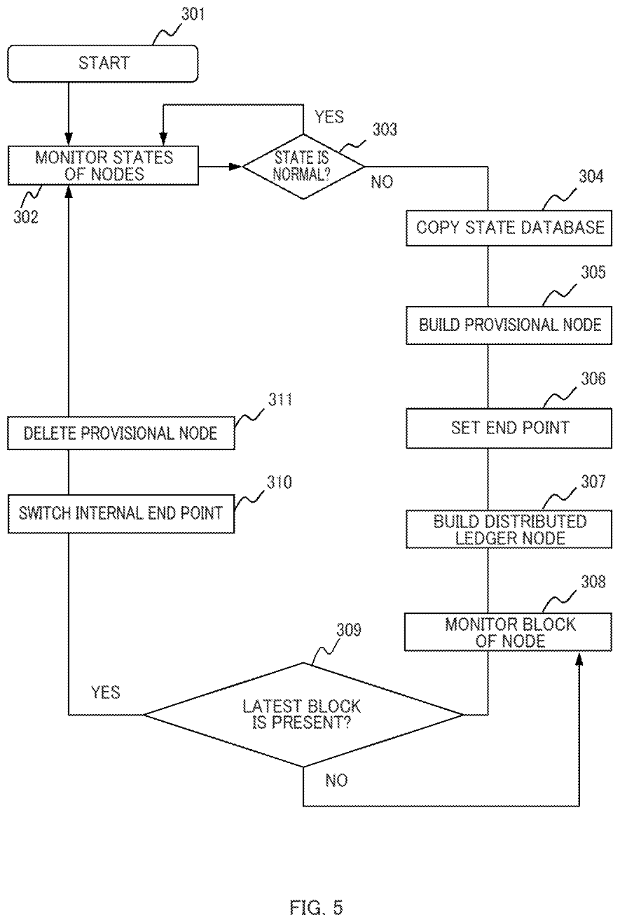

FIG. 5 is a flow example of the distributed ledger management method in the embodiment, more specifically a flowchart of the dependable node 201. In this case, the dependable node 201 is activated, for example, when a fixed time comes, and starts the processing (step 301).

Next, the dependable node 201 monitors the state of each of the distributed ledger nodes 401 whose access point information is written in the database 202 (step S302).

Moreover, the dependable node 201 determines whether each of nodes has an abnormality or not based on the result of the aforementioned monitoring (step S303). If the node is normal in the result of the aforementioned determination (step 303: YES), the dependable node 201 causes the processing to return to step 302 and continues monitoring the state regularly.

Meanwhile, if the dependable node 201 detects occurrence of abnormality in the result of the aforementioned determination (step 303: NO), the dependable nodes 201 causes resources of its organization in which no abnormality is occurring or that are not affected by the abnormality to obtain and copy the state database 106 from the distributed ledger node 401 of another organization (step 304) to restore the distributed ledger node.

Moreover, the dependable nodes 201 builds the provisional node 101 based on the aforementioned state database 106 obtained and copied in the step 304 and activates the provisional node 101 (step 305). The method of building the provisional node 101 is as described above.

Next, the dependable node 201 writes the information on the access point of the aforementioned provisional node 101 built and activated in the step 305 into the database 202, as information on a reception point (end point) of transactions in this organization from hereon (step 306).

Moreover, the dependable node 201 builds the distributed ledger node 401A to be restored and activates the distributed ledger node 401A (step 307). This distributed ledger node 401A obtains a block of (genesis block or backup block at a certain time point) of the blockchain 402 in the latest state from the dependable node 201 or the distributed ledger node 401 of the other organization, executes block recalculation with this block being a starting point, and builds the state database 106 from scratch.

Next, the dependable node 201 monitors the height of the block (whether the block is latest or not) held by the aforementioned distributed ledger node 401A built in step 307 (step 308). This monitoring can be assumed to be an operation executed by using an algorithm that compares information on the latest block notified by an orderer with information on the last block in the distributed ledger node 401A and determines that the last block is the latest block if both blocks match each other.

If the block of the distributed ledger node 401A is not the latest block in the result of the aforementioned monitoring (step 309: NO), the dependable node 201 causes the processing to return to step 308 and continues monitoring the height of the block in the distributed ledger node 401A.

Meanwhile, if the block of the distributed ledger node 401A is the latest block in the result of the aforementioned monitoring (step 309: YES), the dependable node 201 writes the information on the access point of the distributed ledger node 401A into the database 202, as the reception point (end point) of transactions in the organization from hereon (step 310).

Next, the dependable node 201 deletes the provisional node 101 built in step 305 (step 311), causes the processing to return to step 302, and continues monitoring the state of each node.

The dependable node 201 repeatedly executes the series of processes described above to appropriately handle events such as failure restoration and addition of a new organization in the distributed ledger system 400.

### Other Embodiment 1

Note that, when the distributed ledger node 401 of a new organization or the like is to be added to the distributed ledger system 400, the dependable node 201 preferably executes the copying of the state database 106 (step 304) and the building of the provisional node 101 (step 305) before the schedule 302 in the flow of FIG. 5, that is just after the start of the flow.

Such an operation allows the endorsement processing by the provisional node 101 to be started as early as possible and service downtime in the addition of the organization can be reduced in the distributed ledger system 400 as a whole.

### Other Embodiment 2

As another embodiment, for example, a configuration in which a data volume is reduced by using the provisional node 101 is conceivable. For example, assume a case where two distributed ledger nodes 401 are launched in one organization. In this case, one of the distributed ledger nodes is set as the provisional node 101 and this can reduce the volume of data held by the organization by half.

The meaning of this is as follows. Although each distributed ledger node needs to have the distributed ledger in a normal configuration, in the present disclosure, the provisional node 101 needs no distributed ledger and the data volume is reduced by half in the distributed ledger system as a whole.

Moreover, the volume of the blocks can be reduced by setting all distributed ledger nodes 401 as the provisional nodes 101. When a failure occurs in this configuration, the dependable node 201 executes the copying of the state database 106 (step 304) and the switching of the internal end point (step 306) in FIG. 5 and then skips the processing to the monitoring of the state of each node (step 302). Effectively using the provisional node 101 as described above can reduce the number of processing steps.

Although the best modes and the like for carrying out the present disclosure have been specifically described above, the present disclosure are not limited to these modes and the like and various changes can be made within a scope not departing for the spirit of the disclosure.

According to the embodiment and the like described above, it is possible to rapidly or seamlessly restart the endorsement in the failure of the distributed ledger system or the addition of the organization and eliminate or reduce downtime of the entire system. Specifically, it is possible to speed up rebuilding of the state database and reduce the downtime of the entire system.

At least the following matters are apparent from the description of this specification. Specifically, in the distributed ledger management method of the embodiment, the management node may further perform the processing of obtaining the latest state database from the predetermined existing node in the addition or the restoration and copying the state database.

According to this method, it is possible to obtain the latest state database from, for example, the distributed ledger node of the organization that is not affected by the failure or the like and is still in a sound state, and effectively and rapidly use this state database for endorsement. This can further speed up the state database rebuilding and reduce the downtime of the entire system.

Moreover, in the distributed ledger management method of the embodiment, the management node may further perform the processing of building the normal distributed ledger node.

According to this method, it is possible to, for example, improve the restoration efficiency of the distributed ledger node for the organization being the target of restoration in the distributed ledger system. This can further speed up the state database rebuilding and reduce the downtime of the entire system.

Furthermore, in the distributed ledger management method of the embodiment, the management node may further perform the processing of deleting the distributed ledger node for endorsement after the broadcast destination is changed to the normal distributed ledger node.

According to this method, after the restoration or the like is achieved, the resources for the distributed ledger node for the endorsement that is no longer necessary are deleted and the efficiency in the entire distributed ledger system is improved. This can further speed up the state database rebuilding and reduce the downtime of the entire system.

Moreover, in the distributed ledger management method of the embodiment, the management node may not give the blocks to the distributed ledger node for the endorsement to reduce the data volume in the target of restoration or the addition.

According to this method, it is possible to perform an operation in which roles are divided among the nodes and the blocks are held only in the node that requires the blocks, and the efficient usage of the resources in the entire distributed ledger system is achieved. This can further speed up the state database rebuilding and reduce the downtime of the entire system.

What is claimed is:

1. A distributed ledger management method implemented by a predetermined management node configured to perform processing, comprising:
building a distributed ledger node for endorsement in restoration of a distributed ledger system or addition of a distributed ledger node;
giving a state database copied from an existing node to the distributed ledger node for endorsement to perform the endorsement and setting the distributed ledger node for endorsement as a broadcast destination of a transaction; and
monitoring a status of block recalculation that is based on a block at a certain time point and that is performed in a normal distributed ledger node for the restoration or the addition and changing the broadcast destination of the transaction to the normal distributed ledger node when calculation of a latest block is detected.

2. The distributed ledger management method according to claim 1, wherein, in the restoration or the addition, the management node is configured to further perform processing of obtaining the latest state database from a predetermined existing node and copying the state database.

3. The distributed ledger management method according to claim 1, wherein the management node is configured to further perform processing of building the normal distributed ledger node.

4. The distributed ledger management method according to claim 1, wherein the management node is configured to further perform processing of deleting the distributed ledger node for endorsement after changing the broadcast destination to the normal distributed ledger node.

5. The distributed ledger management method according to claim 1, wherein the management node is configured to reduce data volume in a target of the restoration or the addition by not giving a block to the distributed ledger node for endorsement.

6. A distributed ledger system comprising a predetermined management node, wherein
the predetermined management node includes a computation device that is configured to perform processing of:
building a distributed ledger node for endorsement in restoration of the distributed ledger system or addition of a distributed ledger node;
giving a state database copied from an existing node to the distributed ledger node for endorsement to perform the endorsement and setting the distributed ledger node for endorsement as a broadcast destination of a transaction; and
monitoring a status of block recalculation that is based on a block at a certain time point and that is performed in a normal distributed ledger node for the restoration or the addition and changing the broadcast destination of the transaction to the normal distributed ledger node when calculation of a latest block is detected.

7. A node comprising a computation device that performs processing of:
building a distributed ledger node for endorsement in restoration of a distributed ledger system or addition of a distributed ledger node;
giving a state database copied from an existing node to the distributed ledger node for endorsement to perform the endorsement and setting the distributed ledger node for endorsement as a broadcast destination of a transaction; and
monitoring a status of block recalculation that is based on a block at a certain time point and that is performed in a normal distributed ledger node for the restoration or the addition and changing the broadcast destination of the transaction to the normal distributed ledger node when calculation of a latest block is detected.
